(19) United States
(12) Patent Application Publication
(10) Pub. No.: US 2022/0165036 A1
(43) Pub. Date: May 26, 2022

(54) EXTENDED REALITY IOT DEVICE MANAGEMENT

(71) Applicant: International Business Machines Corporation, Armonk, NY (US)

(72) Inventors: Stan Kevin Daley, Atlanta, GA (US); Michael Bender, Rye Brook, NY (US); Sarbajit K. Rakshit, Kolkata (IN)

(21) Appl. No.: 17/104,201

(22) Filed: Nov. 25, 2020

(51) Int. Cl. G06T 19/00; H04L 29/08; G02B 27/01; G06F 3/01

(52) U.S. Cl. CPC G06T 19/006; H04L 67/16; G02B 2027/0178; G06F 3/011; G06F 3/017; G02B 27/0172

(57) ABSTRACT

A plurality of internet of things (IoT) devices in an environment can be identified. An extended reality (XR) representation of the environment and the plurality of IoT devices can be generated. The XR representation of the environment and the plurality of IoT devices can be presented to a user. Input can be received from the user modifying a setting of at least one IoT device of the plurality of IoT devices through the XR representation of the environment. The setting of the at least one IoT device can then be modified according to the received input.

### BACKGROUND

The present disclosure relates generally to the field of extended reality (XR), and in particular, to XR-based internet of things (IoT) device management.

Virtual Reality (VR) systems and Augmented Reality (AR) systems, herein collectively referred to as extended reality (XR) systems, simulate virtual environments using computer technology. XR systems provide sensory data (e.g., audio and visual data) to users such that the users experience an immersive environment. XR systems typically include a wearable display (e.g., a head-mounted display (HMD) or glasses) used to visualize a simulated environment. The simulated environment can be similar to the real world or entirely fictional.

Internet of things (IoT) devices are objects embedded with sensors, software, and other technology that can exchange data with other devices and systems over the Internet. For example, “smart home” IoT devices can include network connected appliances such as lighting fixtures, thermostats, security systems, refrigerators, dishwashers, and other home appliances. However, IoT devices have applications in many fields including medical, transportation, agriculture, and the military, among others. IoT capabilities enhance user experience through functionalities such as remote monitoring and control. Sensor data collected from IoT devices can be analyzed and used to issue control signals.

### SUMMARY

Embodiments of the present disclosure are directed to a method, system, and computer program product for XR-based IoT device management. A plurality of internet of things (IoT) devices in an environment can be identified. An extended reality (XR) representation of the environment and the plurality of IoT devices can be generated. The XR representation of the environment and the plurality of IoT devices can be presented to a user. Input can be received from the user modifying a setting of at least one IoT device of the plurality of IoT devices through the XR representation of the environment. The setting of the at least one IoT device can then be modified according to the received input.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating an example computing environment in which illustrative embodiments of the present disclosure can be implemented.

FIG. 2 is a block diagram illustrating an IoT environment, in accordance with embodiments of the present disclosure.

FIG. 3 is a flow-diagram illustrating an example method for XR-based IoT device management, in accordance with embodiments of the present disclosure.

FIG. 4 is a flow-diagram illustrating an example method for managing XR-based setting changes to IoT devices, in accordance with embodiments of the present disclosure.

FIG. 5 is a high-level block diagram illustrating an example computer system that can be used in implementing one or more of the methods, tools, modules, and any related functions described herein, in accordance with embodiments of the present disclosure.

FIG. 6 is a diagram illustrating a cloud computing environment, in accordance with embodiments of the present disclosure.

FIG. 7 is a block diagram illustrating abstraction model layers, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of extended reality (XR), and in particular, to XR-based internet of things (IoT) device management. While the present disclosure is not necessarily limited to such applications, various aspects of the disclosure can be appreciated through a discussion of various examples using this context.

Internet of things (IoT) devices are objects embedded with sensors, software, and other technology that can exchange data with other devices and systems over the Internet. For example, “smart home” IoT devices can include network connected appliances such as lighting fixtures, thermostats, security systems, refrigerators, dishwashers, and other home appliances. However, IoT devices have applications in many fields including medical, transportation, agriculture, and the military, among others. IoT capabilities enhance user experience through functionalities such as remote monitoring and control. Sensor data collected from IoT devices can be analyzed and used to issue control signals (e.g., proportional-integral-derivative (PID) control).

As IoT devices become more prevalent, there is a need to conveniently and intuitively control each IoT device within a given IoT network. Though mobile device applications allow adjusting IoT settings of individual IoT devices over a network, these controls may not be intuitive as they may not mirror the control input that is completed in-person (e.g., turning a dial in-person versus setting a percentage on an application). Further, remote control of IoT devices may result in undesirable control inputs as a result of the user being disconnected from the environment in which the IoT device operates.

Aspects of the present disclosure relate to XR-based IoT device management. A plurality of internet of things (IoT) devices in an environment can be identified. An extended reality (XR) representation of the environment and the plurality of IoT devices can be generated. The XR representation of the environment and the plurality of IoT devices can be presented to a user, for example, through an XR display device. Input can be received from the user modifying a setting of at least one IoT device of the plurality of IoT devices through the XR representation of the environment. The setting of the at least one IoT device can then be modified according to the received input.

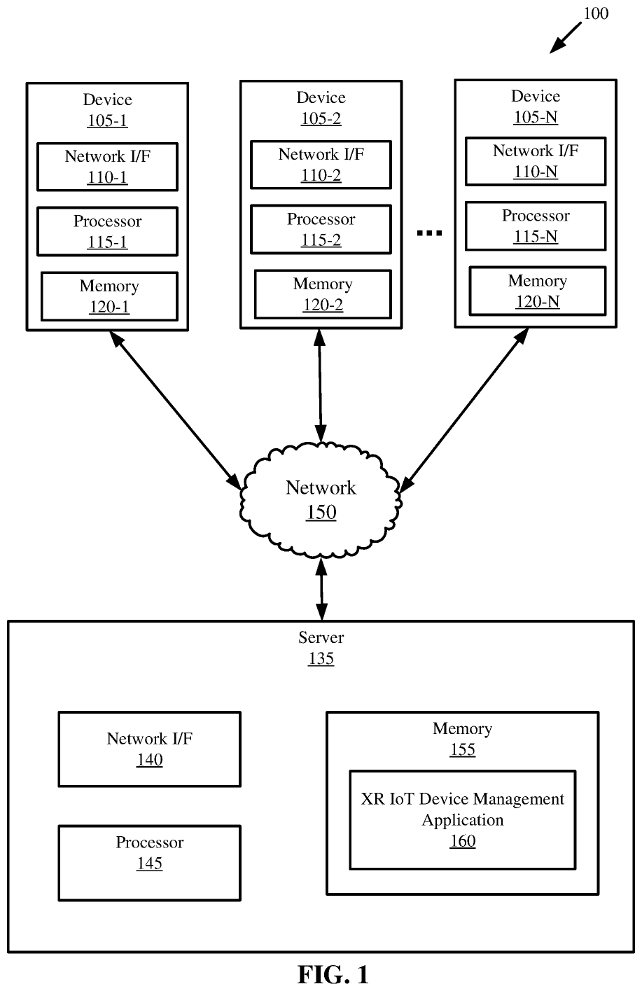

Turning now to the figures, FIG. 1 is a block diagram illustrating an example computing environment 100 in which illustrative embodiments of the present disclosure can be implemented. Computing environment 100 includes a plurality of devices 105-1, 105-2 . . . 105-N (collectively devices 105), at least one server 135, and a network 150.

The devices 105 and the server 135 include one or more processors 115-1, 115-2 . . . 115-N (collectively processors 115) and 145 and one or more memories 120-1, 120-2 . . . 120-N (collectively memories 120) and 155, respectively. The devices 105 and the server 135 can be configured to communicate with each other through internal or external network interfaces 110-1, 110-2 . . . 110-N (collectively network interfaces 110) and 140. The network interfaces 110 and 140 are, in some embodiments, modems or network interface cards. The devices 105 and/or the server 135 can be equipped with a display or monitor. Additionally, the devices 105 and/or the server 135 can include optional input devices (e.g., a keyboard, mouse, scanner, a biometric scanner, video camera, or other input device), and/or any commercially available or custom software (e.g., browser software, communications software, server software, natural language processing software, search engine and/or web crawling software, image processing software, etc.). The devices 105 and/or the server 135 can be servers, desktops, laptops, financial transaction terminals, or hand-held devices.

The devices 105 and the server 135 can be distant from each other and communicate over a network 150. In some embodiments, the server 135 can be a central hub from which devices 105 can establish a communication connection, such as in a client-server networking model. Alternatively, the server 135 and devices 105 can be configured in any other suitable networking relationship (e.g., in a peer-to-peer (P2P) configuration or using any other network topology).

In some embodiments, the network 150 can be implemented using any number of any suitable communications media. For example, the network 150 can be a wide area network (WAN), a local area network (LAN), an internet, or an intranet. In certain embodiments, the devices 105 and the server 135 can be local to each other and communicate via any appropriate local communication medium. For example, the devices 105 and the server 135 can communicate using a local area network (LAN), one or more hardwire connections, a wireless link or router, or an intranet. In some embodiments, the devices 105 and the server 135 can be communicatively coupled using a combination of one or more networks and/or one or more local connections. For example, the first device 105-1 can be hardwired to the server 135 (e.g., connected with an Ethernet cable) while the second device 105-2 can communicate with the server 135 using the network 150 (e.g., over the Internet).

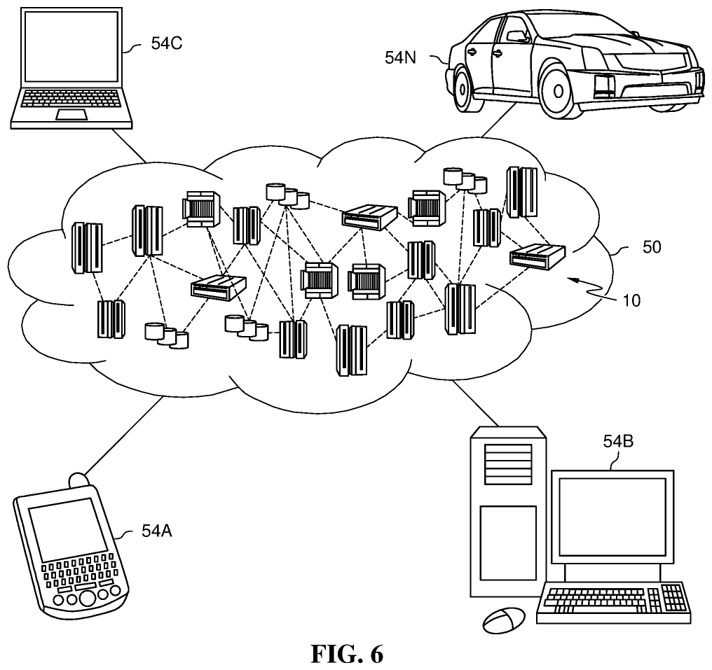

In some embodiments, the network 150 is implemented within a cloud computing environment or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 150. In some embodiments, the network 150 may be substantially similar to, or the same as, cloud computing environment 50 described in FIG. 6.

The server 135 includes an extended reality (XR) internet of things (IoT) device management application 160. The XR IoT device management application 160 can be configured to generate and present an XR environment including XR representations of IoT devices (e.g., devices 105) to a user such that the user can control the IoT devices through the XR environment.

The XR IoT device management application 160 can first be configured to identify a plurality of IoT devices within a given environment (e.g., a building, factory, house, kitchen, etc.). In embodiments, identifying IoT devices can be completed via user registration. For example, a user can register each of a plurality of devices by submitting specifications of each device, submitting images of each device, specifying the capabilities and/or dimensions of each device, specifying interactive control features of each device, and/or naming each device. However, in some embodiments, identifying IoT devices can be done automatically based on received sensor data (e.g., data from a camera within an environment can be collected and analyzed to identify one or more IoT devices).

Upon identifying IoT devices within the environment, the XR IoT device management application 160 can be configured to generate an XR simulation of the environment including the IoT devices. In embodiments, a user can register the environment associated with the IoT devices by, for example, submitting images, videos, blueprints, and/or other characterizing information of the environment such that an XR representation of the environment can be generated. For example, an XR representation of an environment can be generated using data received from an XR camera, a 360 panorama camera, a spherical camera, or a video camera. In some embodiments, photogrammetry techniques can be used to convert a real world environment into an XR representation. However, in some embodiments, the XR representation including the IoT devices does not necessarily have to mirror the environment in which the IoT devices reside. For example, the environment can be entirely fictional (e.g., a scene of a meadow or castle) which includes the IoT devices organized in a particular manner. Ultimately, an XR environment is generated which includes XR representations of the IoT devices.

Interactive features of each IoT device can be added to the XR environment. For example, interactive features native to each IoT device (e.g., a dial, buttons, a touch screen display) can be integrated into the XR environment such that the user can interact with each device within the XR environment in a similar manner as they would interact with the IoT device in the real world. Thus, input received within the XR environment (e.g., through a user device such as a mobile device, the XR display device, a wearable, a VR controller, haptic gloves, etc.) can be used to control settings of the IoT devices within the XR environment. In some embodiments, the interactive features added to each IoT device within the XR environment do not necessarily have to mirror the interactive features of the IoT device in the real world. For example, one or more switches, buttons, dials, etc. can be added as interactive features of IoT devices within the XR environment that are not associated with the IoT device in the real world.

Upon generating the XR representation of the IoT devices and the environment, the XR IoT device management application 160 presents the XR representation to a user. This can be completed using an XR display device (e.g., augmented reality (AR) goggles, a virtual reality (VR) head mounted display (HMD), etc.) worn by the user. The user can then select a device to interact with within the XR environment (e.g., using a pointer/cursor, voice command, gesture, etc.). Upon selection of an IoT device, the user can interact with one or more of the interactive features of the IoT device within the XR environment through a user device, such as a VR controller, a wearable, or the XR display device. The input received from the user can then be used to modify one or more settings of the IoT device according to the input. For example, in response to receiving an input to “power on” a first IoT device from a user within the XR environment, the XR IoT device management application 160 can be configured to power on the first IoT device in the real world (e.g., by issuing a command over network 150). Thus, the XR IoT device management application 160 can facilitate user control of settings of various IoT devices within an XR environment without a user having to be physically proximate to the IoT devices in the real word.

In some embodiments, the XR IoT device management application 160 can be configured to determine whether one or more setting changes are adverse, and in response to determining that one or more setting changes are adverse, issue an action to address the adverse setting change. For example, the XR IoT device management application 160 can be configured to determine, based on previous training data and/or contextual data (e.g., image data) within the real world environment, that a setting change is adverse. In response to determining that the setting change is adverse, the XR IoT device management application 160 can be configured to warn the user of the setting change, prevent the setting change, and/or modify the setting change such that the adverse setting change does not cause complications.

It is noted that FIG. 1 is intended to depict the representative major components of an example computing environment 100. In some embodiments, however, individual components can have greater or lesser complexity than as represented in FIG. 1, components other than or in addition to those shown in FIG. 1 can be present, and the number, type, and configuration of such components can vary.

While FIG. 1 illustrates a computing environment 100 with a single server 135, suitable computing environments for implementing embodiments of this disclosure can include any number of servers. The various models, modules, systems, and components illustrated in FIG. 1 can exist, if at all, across a plurality of servers and devices. For example, some embodiments can include two servers. The two servers can be communicatively coupled using any suitable communications connection (e.g., using a WAN, a LAN, a wired connection, an intranet, or the Internet).

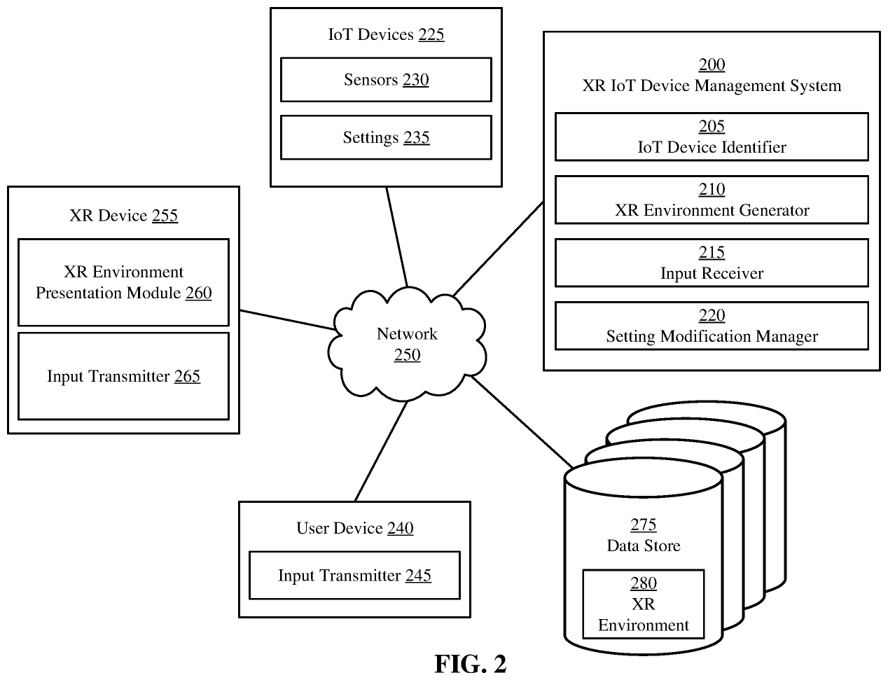

Referring now to FIG. 2, illustrated is a block diagram of an example Internet of Things (IoT) environment according to aspects of the present disclosure. The IoT environment can include numerous components communicatively coupled by a network 250, such as, but not limited to, an XR IoT device management system 200, IoT devices 225, an XR device 255, a user device 240, and a data store 275. The various components within the IoT environment can be processor executable instructions that can be executed by a dedicated or shared processor using received inputs.

The XR IoT device management system 200 can be configured to generate an XR representation of an environment including XR representations of IoT devices 225 with virtually interactable features. This can be completed such that a user can control the IoT devices 225 remotely, without requiring the user to be physically proximate to the IoT devices 225. Further, this allows the user to control the IoT devices 225 in a similar manner as would be completed if they were physically present. For example, the interactive features (e.g., buttons, dials, switches, touch screens, etc.) of each IoT device 225 can be integrated into the XR environment such that the user can modify one or more settings 235 of the IoT devices 225 by interacting with the virtually interactive features using user device 240 or XR device 255.

An IoT device identifier 205 of the XR IoT device management system 200 can be configured to identify one or more IoT devices 225 to be integrated into an XR representation of an environment. In embodiments, identifying IoT devices 225 can be completed by a user through a registration process. For example, a user can specify the name of each device, physical attributes of each device (e.g., dimensions), and interactive features of each device. In some embodiments, the user can upload images, videos, specifications, or other data describing the physical and functional aspects of each IoT device 225. This can be used such that XR representations of each IoT device 225 can be generated and integrated into an XR representation of the environment.

In some embodiments, the IoT device identifier 205 can automatically identify each device without user intervention. For example, the XR IoT device management system 200 can obtain information regarding each IoT device 225 through network 250, for example, by inspecting device identifiers (e.g., media access control (MAC) addresses) associated with each IoT device 225. In some embodiments, sensor data received from sensors 230 of IoT devices 225 within the environment can be used to identify IoT devices 225. For example, sensor data received from a camera can be used to identify each IoT device 225 such that an XR representation of each IoT device 225 can be generated. Ultimately, an XR representation of each device can be generated based on the characterizing information (e.g., dimensions and images of each IoT device) associated with each device.

An XR environment generator 210 can be configured to generate an XR representation of a given environment including IoT devices 225 identified by the IoT device identifier 205. The XR environment generator 210 can be configured to generate an XR representation of an environment including XR representations of IoT devices 225 in any suitable manner. In some embodiments, data received from an imaging device (e.g., an XR camera, a spherical camera, a 360 panorama camera, a video camera, a smart phone camera, etc.) can be translated into a virtual representation. In some embodiments, photogrammetry techniques can be used to generate an XR representation of an environment based on one or more images. In some embodiments, an application (e.g., image to VR conversion software) can be used to convert one or more images into an XR representation of an environment.

The XR environment generator 210 can be configured to add XR representations of IoT devices 225 to the XR environment. For example, based on characterizing information (e.g., images, dimensions, interactive features, etc.) collected for each IoT device 225, the XR environment generator 210 can generate an XR representation of each IoT device 225 and integrate each XR representation of each IoT device 225 into the XR environment. In embodiments, the position of each XR representation of each IoT device 225 within the XR environment can be specified by a user. In some embodiments, the position of each XR representation of each IoT device 225 can be based on the location of each IoT device 225 within the real world (e.g., in embodiments where the XR environment mirrors the real world setting where the IoT devices 225 reside).

The XR representations of IoT devices 225 can resemble the IoT devices' 225 appearance in the real world (e.g., in embodiments where XR representations of IoT devices 225 are generated using images of the IoT devices 225). However, in some embodiments the XR representations of IoT devices 225 can differ from IoT devices' 225 appearance in the real world. For example, the XR representations of IoT devices 225 can be simplified versions of IoT devices 225. As another example, the XR representations of IoT devices 225 can be symbols, avatars, letters, numbers, or other virtual representations.

The XR environment generator 210 can further be configured to add interactive features (e.g., virtually interactable controls) to each XR representation of each IoT device 225 within the XR environment. Interactive features can include input mechanisms such as buttons, dials, switches, touch screen interfaces, and voice commands, among others. In some embodiments, interactive features associated with the IoT devices 225 in the real world can be mirrored into the XR environment. For example, if a first IoT device has three buttons and a dial within the real-world, the three buttons and the dial can be integrated (e.g., programmed) into the XR environment such that a user can interact with the same interactive features within the XR environment. Thus, if a user activates one of the buttons within the XR environment, the XR IoT device management system 200 can be configured to activate the functionality of the button in the real world over the network 250. However, in embodiments, interactive features associated with each XR representation of each IoT device 225 do not necessarily have to mirror the interactive features each IoT device has in the real world. For example, one or more buttons, switches, dials, touch displays, etc. can be added to an XR representation of an IoT device that the IoT device does not include in the real world.

In embodiments, the XR environment generator 210 can be configured to generate an XR environment that mirrors the environment in which the IoT devices 225 are located. In these embodiments, the location of each IoT device 225 within the environment may already be known by the user, allowing the user to comfortably navigate through the XR space to modify one or more settings of IoT devices 225. In some embodiments, the XR environment generator 210 can generate an environment which differs from the environment where the IoT devices 225 are located. For example, the XR environment generator 210 can generate an XR environment that is entirely fictional based on a received pre-generated XR template (e.g., a template which includes an XR environment that was previously generated, such as a fictional or non-fictional scene). Thereafter, the XR environment generator 210 can be configured to append XR representations of IoT device 225 to the XR environment.

In embodiments, the XR environment generator 210 can be configured to generate multiple XR environments, each XR environment having a set of XR representations of IoT devices 225. The XR environment generator 210 can be configured to store each XR environment 280 in data store 275. Thus, a user can navigate through various XR environments, each having a unique set of XR representations of IoT devices 225. As an example, a first XR environment can be a kitchen setting (e.g., having IoT-enabled appliances such as a smart refrigerator, smart dishwasher, smart sink, smart stovetop, smart oven, etc.), a second environment can be a laundry room setting (e.g., having an IoT-enabled washer/dryer), and a third environment can be a garage setting (e.g., having an IoT-enabled autonomous vehicle and garage door).

Upon configuring XR environments 280 with XR representations of IoT devices 225, the XR environments 280 can be presented to a user over network 250 on an XR device 255. The XR device 255 can be any suitable device configured to display XR data to a user, including, but not limited to, augmented reality (AR) displays (e.g., AR glasses) and virtual reality (VR) displays (e.g., a VR head-mounted display (HMD)). An XR environment presentation module 260 of the XR device 255 can be configured to display XR content to the user. The user can then provide input to control aspects within XR through an input transmitter 265 of the XR device 255 and/or an input transmitter 245 of user device 240 (e.g., a mobile device or smart watch). For example, the user can provide input to select a desired XR environment 280 (e.g., select the set of IoT devices 225 they desire to control), to select a desired IoT device 225 (e.g., select the specific IoT device 225 they desire to control), or to modify settings 235 of IoT devices 225 via virtually interactable features.

A user can select an XR environment 280 (of a plurality of XR environments) to interface in any suitable manner. In some embodiments, a menu displaying all available XR environments can be displayed by the XR environment presentation module 260 upon initiation of the system. The user can then select, using any suitable input mechanism (e.g., a voice command, cursor, button, etc.), the XR environment 280 they wish to control. The XR environment 280 selected by the user can then be displayed to the user.

Similarly, a user can select an IoT device 225 to interface within an XR environment in any suitable manner. For example, the user can navigate through the XR environment, using XR locomotion options (e.g., teleport movement, smooth motion movement, drag movement), to the location of an IoT device 225 they wish to interface with. The user can then provide input (e.g., selection of a button, selection with a cursor, voice activation) selecting the IoT device 225 to interface. However, an IoT device 225 can be selected in any other suitable manner. For example, a menu of available IoT devices 225 (e.g., a list) can be presented to a user on the XR device 255 and the user can select an IoT device 225 on the menu that they desire to control.

Upon selecting an IoT device 225 to interface, the user can change one or more settings 235 of the IoT device 225 by interacting with a virtually interactable control of the IoT device. In particular, the user can provide inputs via input transmitter 245 of user device 240 and/or input transmitter 265 of XR device 255 to interact with virtually interactable controls associated with the IoT device 225. The inputs transmitted by the user can then be received by an input receiver 215 of the XR IoT device management system 200. A setting modification manager 220 can then be configured to alter settings 235 of the IoT devices 225 over network 250 according to the received input 215.

Any suitable input can be used to interact with virtually interactable features of XR representations of IoT devices 225 through the XR device 255 and/or user device 240. For example, inputs can include touch screen controls, motion controls (e.g., gyroscopes and/or accelerometers associated with XR device 255 or user device 240 can provide input), button controls, dial controls, and voice controls, among others. For example, if a user selects a first IoT device with a virtually interactable dial, the user can control the dial based on motion control of the user device 240, by rotating the user device 240 a corresponding amount (e.g., as captured by a gyroscope) to be translated to turn the dial. Thereafter, the motion control can be received by the input receiver 215 and used to by the setting modification manager 220 to adjust the settings 235 of the first IoT device. In some embodiments, physical gestures, as captured by a camera, can be translated into a corresponding input to be used to control IoT devices 225. In some embodiments, virtual control features (e.g., buttons, switches, dials, etc.) within the XR environment can be interacted with using the XR device 255 or user device 240 (e.g., a virtual button can be pressed by bringing user device 240 in proximity with the virtual button within the XR environment to activate the virtual button). However, any suitable input through the XR device 255 and/or user device 240 can be used to interact with virtually interactable features of IoT devices 225.

In embodiments, setting modification manager 220 can be configured to determine whether a setting change of an IoT device is adverse, and in response to determining that the setting change is adverse, issue an action to address the potentially adverse setting change. Determining whether a setting change is adverse can be completed based on previous training data and/or based on contextual data within the IoT device 225 environment. Actions used to address the adverse setting change can include preventing the setting change, modifying the setting change (e.g., only modifying the setting by 25% versus 50%), and/or warning the user of the setting change.

In embodiments, a corpus of training data indicating outcomes (e.g., negative or positive) based on IoT device 225 setting modifications can be stored. The corpus can indicate outcome-to-setting change mappings based on ingested data describing each IoT device, such as manuals, warnings, safety guidelines, or other trusted sources. For example, a manual of an IoT device can indicate that a particular IoT device setting change could be dangerous. Thus, the setting modification manager 220 can prevent or otherwise deter the setting change based on the indication in the manual.

The corpus can further include outcomes based on previous setting changes of IoT devices. In embodiments, supervised learning data can be received by a user indicating the outcome of a previous setting change. For example, if settings of a first IoT device were changed in a particular manner, and the user indicated that the setting change was adverse, the setting modification manager 220 can use this feedback to address future, similar, setting changes. In some embodiments, unsupervised learning data can be received which maps outcomes to setting changes. For example, secondary actions taken in the real-world environment in response to a setting change could be mapped to a corresponding outcome. As an example, if a user increased a volume setting on a first IoT device, and it led to a secondary action of a nearby door closing, then the setting change could be determined to be negative. In this example, the setting modification manager 220 could prevent or modify future volume setting adjustments based on the secondary action within the environment of the volume change.

In some embodiments, contextual data (e.g., image data and audio data) in the real world environment including the IoT device for which the setting was changed can be used by the setting modification manager 220 to manage setting changes. For example, if smoke is detected in an image, or a fire alarm is detected in an audio recording, then a setting change increasing heat of a heating IoT device can be prevented by the setting modification manager 220. As another example, if a setting change is made to an autonomous vehicle to turn the autonomous vehicle on while it is parked in a closed garage (e.g., as indicated by a garage door sensor or a video recording of the garage), a determination can be made to prevent the car from being turned on, to open the garage door, and/or to power off the car. Setting modification manager 220 can modify settings based on any suitable contextual indication for any suitable IoT device.

It is noted that FIG. 2 is intended to depict the representative major components of example computing environment. In some embodiments, however, individual components can have greater or lesser complexity than as represented in FIG. 2, components other than or in addition to those shown in FIG. 2 can be present, and the number, type, and configuration of such components can vary.

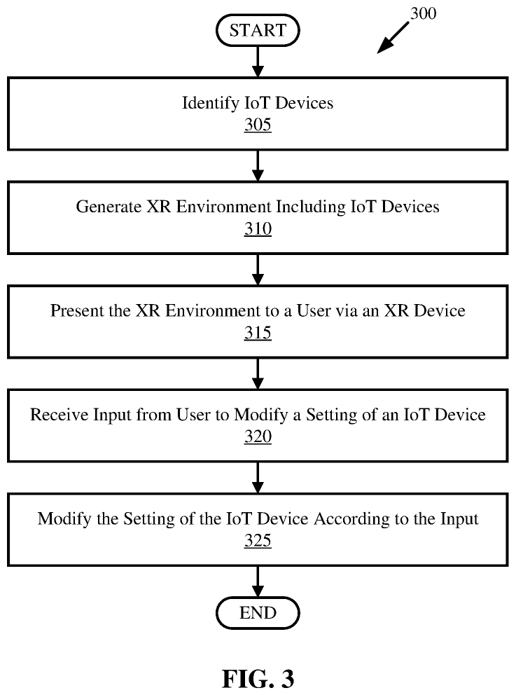

Referring now to FIG. 3, shown is a flow-diagram illustrating an example method 300 for XR-based IoT device management, in accordance with embodiments of the present disclosure. One or more operations of method 300 can be completed by one or more computing devices (e.g., devices 105, server 135, IoT devices 225, XR device 255, XR IoT device management system 200, user device 240).

Method 300 initiates at operation 305, where IoT devices are identified. IoT devices can be identified in the same, or a substantially similar manner, as described with respect to the IoT device identifier 205 of FIG. 2. For example, IoT devices can be identified by a user through a registration process or automatically based on received sensor data.

An XR environment including XR representations of IoT devices is then generated. This is illustrated at operation 310. Generating the XR environment can be completed the same, or a substantially similar manner, as described with respect to the XR environment generator 210 of FIG. 2. For example, photogrammetry techniques can be used to translate a real-world environment into a virtual environment based on received image data. Further, characteristics of each IoT device (e.g., images or dimension) can be used to generate XR representations of each IoT device to be added to the XR environment. Further still, interactable features can be added to each XR representation of each IoT device, which may be based on the interactable features available to the IoT device in the real world.

The XR environment is then presented to a user through an XR device. This is illustrated at operation 315. For example, the user can wear AR glasses or a VR HMD to view the XR environment generated at operation 310. In some embodiments, the user can select the XR environment from a set of XR environments that are stored, each XR environment within the set having a unique corresponding set of XR representations of IoT devices. In embodiments, the user can then select (e.g., using a cursor) an IoT device within the XR environment to modify.

Input is then received from the user to modify a setting of an IoT device. This is illustrated at operation 320. Any suitable input described with respect to FIG. 2 can be received by the user. For example, touch screen controls, button controls, dial controls, motion controls, voice commands, virtually interactable controls, and other control inputs can be utilized by the user. The inputs can be received on a user device (e.g., a smart phone, wearable, virtual reality controller, tablet, computer, etc.) or on the XR device (e.g., a touch screen or microphone associated with the XR device). The input can translate into a corresponding setting change of the IoT device based on interaction with the virtually interactable feature (via the input).

The setting change is then modified according to the received input. This is illustrated at operation 325. For example, if the user activates a button, turns a dial, selects a power level, makes a gesture leading to a first action, etc., a corresponding setting change can be issued to the IoT device within the real world over a network.

The aforementioned operations can be completed in any order and are not limited to those described. Additionally, some, all, or none of the aforementioned operations can be completed, while still remaining within the spirit and scope of the present disclosure.

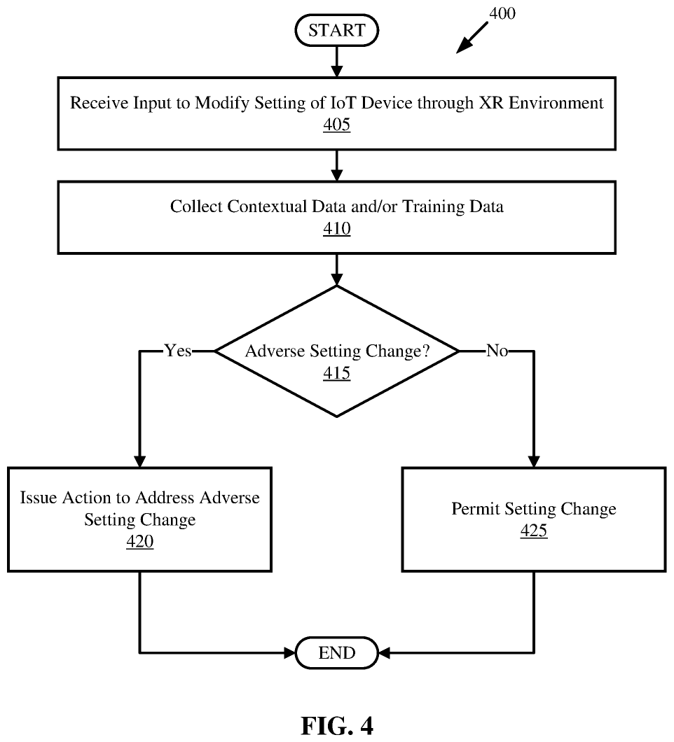

Referring now to FIG. 4, shown is a flow-diagram illustrating an example method 400 for managing the modification of settings, in accordance with embodiments of the present disclosure. One or more operations of method 400 can be completed by one or more computing devices (e.g., devices 105, server 135, IoT devices 225, XR device 255, XR IoT device management system 200, user device 240).

Method 400 initiates at operation 405, where an input is received to modify a setting of an IoT device through an XR environment. This is illustrated at operation 405. Contextual data and/or training data is then collected. This is illustrated at operation 410. For example, the real world environment where the IoT device for which the setting was changed resides can be analyzed by collecting sensor data from surrounding sensors (e.g., cameras, microphones, and other sensors). Further, training data such as manuals, warnings, supervised learning data (e.g., user indicated feedback regarding previous setting changes), and unsupervised learning data (e.g., contextually derived feedback regarding previous setting changes) can be collected.

A determination is then made whether the setting change is adverse. This is illustrated at operation 415. Determining whether the setting change is adverse can be completed based on the analyzed contextual data and/or training data. For example, if a particular condition (e.g., smoke is detected, a substance is burned, water is leaking, an alarm is triggered, a lifeform is detected proximate to the IoT device, etc.) is observed within the contextual data, then a determination can be made that the setting change is adverse. The conditions which lead to determining adverse setting changes for particular IoT devices can vary. For example, conditions leading to an adverse setting change determination for an oven (e.g., smoke observation) may differ from a washing machine (e.g., leaking water) which may differ from factory equipment (e.g., a human detected in proximity to heavy machinery). In embodiments, a data store of adverse conditions can be stored for each IoT device such that setting changes can be managed based on observed contextual data.

Additionally, training data mapping outcomes to previous setting changes can also be analyzed to determine whether a setting change is adverse. For example, unsupervised and supervised learning data can be analyzed to determine if the setting change is substantially similar (e.g., within a threshold value) to a previously issued negative setting change. If a determination is made that the setting change is substantially similar to a previously issued negative setting change, then a determination can be made that the setting change is adverse. In embodiments, a data store having mappings of outcomes (e.g., indicated in a supervised or unsupervised manner) to setting changes can be referenced when determining whether a setting change is adverse.

If a determination is made that the setting change is adverse, then an action is issued to address the adverse setting change. This is illustrated at operation 420. For example, addressing the adverse setting change can include preventing the setting changing, modifying the setting change, and/or warning the user regarding the setting change.

If a determination is made that the setting change is not adverse, then the setting change is permitted. This is illustrated at operation 425. Thus, the settings of the IoT device can be remotely altered.

The aforementioned operations can be completed in any order and are not limited to those described. Additionally, some, all, or none of the aforementioned operations can be completed, while still remaining within the spirit and scope of the present disclosure.

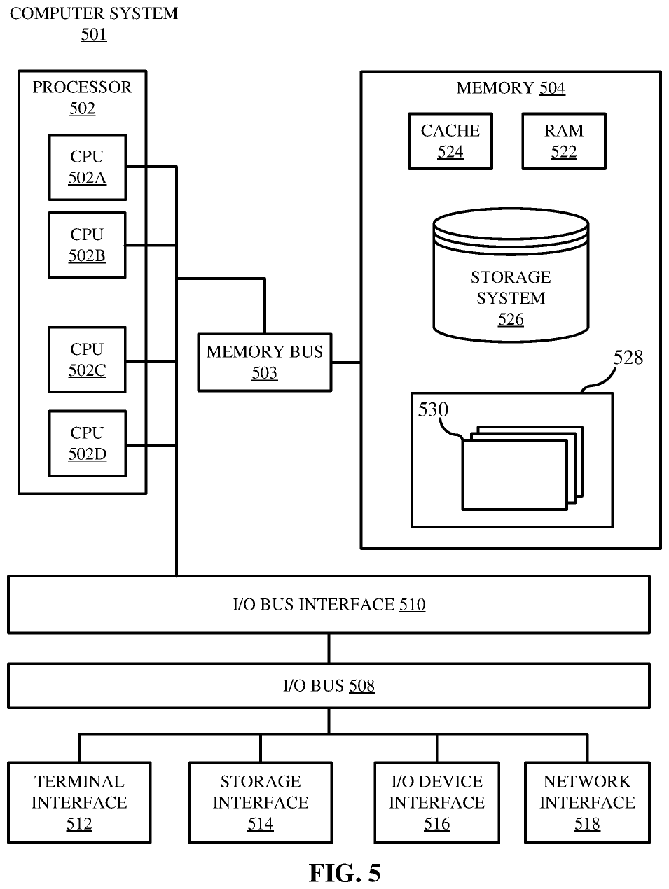

Referring now to FIG. 5, shown is a high-level block diagram of an example computer system 501 that may possibly be utilized in various devices discussed herein (e.g., devices 105, server 135, IoT devices 225, XR device 255, XR IoT device management system 200, user device 240) and that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502 (also referred to as processors herein), a memory 504, a terminal interface 512, a storage interface 514, an I/O (Input/Output) device interface 516, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache.

Memory 504 may include computer system readable media in the form of volatile memory, such as random-access memory (RAM) 522 or cache memory 524. Computer system 501 may further include other removable/non-removable, volatile/non-volatile computer system storage media. By way of example only, storage system 526 can be provided for reading from and writing to a non-removable, non-volatile magnetic media, such as a “hard-drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 504 can include flash memory, e.g., a flash memory stick drive or a flash drive. Memory devices can be connected to memory bus 503 by one or more data media interfaces. The memory 504 may include at least one program product having a set (e.g., at least one) of program modules that are configured to carry out the functions of various embodiments.

One or more programs/utilities 528, each having at least one set of program modules 530 may be stored in memory 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 528 and/or program modules 530 generally perform the functions or methodologies of various embodiments.

Although the memory bus 503 is shown in FIG. 5 as a single bus structure providing a direct communication path among the CPUs 502, the memory 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A (e.g., devices 105), desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

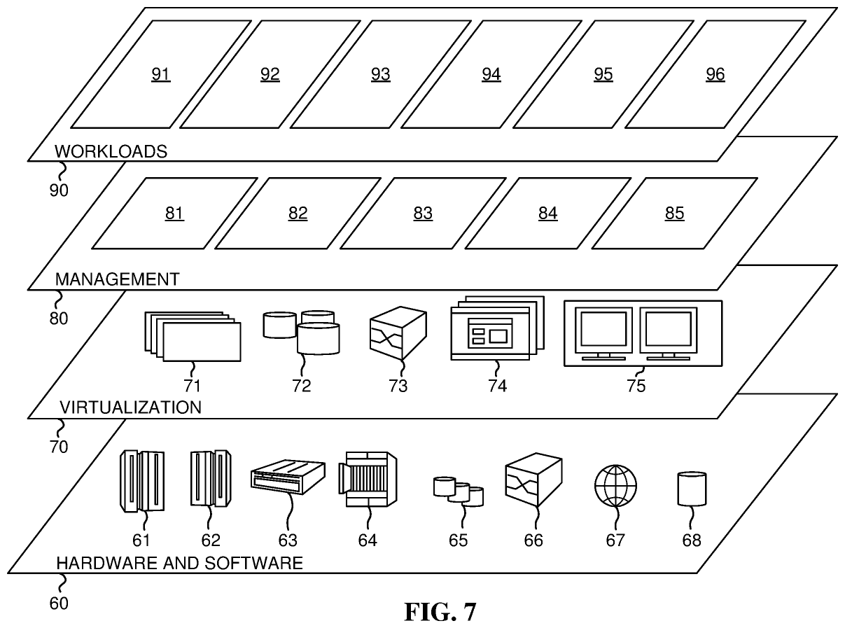

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and XR-based IoT device management 96.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used, and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A method comprising:
identifying a plurality of IoT devices in an environment;
generating an extended reality (XR) representation of the environment and the plurality of IoT devices;
presenting the XR representation of the environment and the plurality of IoT devices to a user;
receiving input from the user modifying a setting of at least one IoT device of the plurality of IoT devices through the XR representation of the environment;
modifying the setting of the at least one IoT device according to the received input:
storing a plurality of additional XR representations of respective environments, each XR representation of each respective environment having a plurality of XR representations of IoT devices;
displaying a menu depicting the plurality of additional XR representations of respective environments to the user facilitating access to the plurality of additional XR representations of respective environments;
receiving input from the user selecting a desired XR environment of the plurality of additional XR representations of respective environments; and
presenting the desired XR environment to the user.

2. The method of claim 1, wherein interactive features of each IoT device of the plurality of IoT devices are integrated into the XR representation, wherein the input includes interaction with at least one interactive feature of the at least one IoT device.

3. The method of claim 1, wherein the XR representation of the environment and the plurality of IoT devices are presented to the user through an XR head-mounted display.

4. The method of claim 1, wherein the input is a motion-based control.

5. The method of claim 1, wherein the plurality of IoT devices are identified based on image data received from a camera, wherein the XR representation of the plurality of IoT devices are generated based on the image data.

6. The method of claim 1, further comprising, prior to modifying the setting:
determining whether the input from the user to modify the setting is adverse; and
modifying, in response to determining that the setting is not adverse, the setting of the at least one IoT device according to the received input.

7. A system comprising:
a memory storing program instructions; and
a processor, wherein the processor is configured to execute the program instructions to perform a method comprising:
identifying a plurality of IoT devices in an environment;
generating an extended reality (XR) representation of the environment and the plurality of IoT devices, wherein a first XR representation of a first IoT device of the plurality of IoT devices has controls that virtually mirror controls of the first IoT device in the real-world, wherein a second XR representation of a second IoT device of the plurality of IoT devices has controls that do not virtually mirror controls of the second IoT device in the real-world, wherein a third XR representation of a third IoT device of the plurality of IoT devices has at least one control that virtually mirrors controls of the third IoT device in the real-world and at least one control that does not virtually mirror the controls of the third IoT device in the real-world;
presenting the XR representation of the environment and the plurality of IoT devices to a user;
receiving input from the user modifying a setting of at least one IoT device of the plurality of IoT devices through the XR representation of the environment; and
modifying the setting of the at least one IoT device according to the received input.

8. The system of claim 7, wherein interactive features of each IoT device of the plurality of IoT devices are integrated into the XR representation, wherein the input includes interaction with at least one interactive feature of the at least one IoT device.

9. The system of claim 7, wherein the XR representation of the environment and the plurality of IoT devices are presented to the user through an XR head-mounted display.

10. The system of claim 7, wherein the input is a virtually interactable input within the XR representation of the environment.

11. The system of claim 7, wherein the plurality of IoT devices are identified based on image data received from a camera, wherein the XR representation of the plurality of IoT devices are generated based on the image data.

12. The system of claim 7, wherein the XR representation of the environment is generated using photogrammetry.

13. The system of claim 7, wherein the method performed by the processor further comprises, prior to modifying the setting:
determining whether the input from the user to modify the setting is adverse; and
modifying, in response to determining that the setting is not adverse, the setting of the at least one IoT device according to the received input.

14. The system of claim 13, wherein determining that the setting is not adverse is based on contextual data collected from at least one sensor within the environment including the plurality of IoT devices.

15. A computer program product comprising a computer readable storage medium having program instructions embodied therewith, the program instructions executable by a processor to cause the processor to perform a method comprising:
identifying a plurality of IoT devices in an environment;
generating an extended reality (XR) representation of the environment and the plurality of IoT devices;
presenting the XR representation of the environment and the plurality of IoT devices to a user;
receiving input from the user modifying a setting of at least one IoT device of the plurality of IoT devices through the XR representation of the environment;
modifying the setting of the at least one IoT device according to the received input;
determining, based on supervised learning data mapping outcomes to previous setting changes, unsupervised learning data indicating contextually derived feedback regarding previous setting changes based on secondary actions taken in the real-world, and a manual associated with the at least one IoT device, whether the modified setting of the at least one IoT device is within a threshold range of a previously issued negative setting change; and
modifying the setting change of the at least one IoT device such that the setting change is not within the threshold range of the previously issued negative setting change.

16. The computer program product of claim 15, wherein interactive features of each IoT device of the plurality of IoT devices are integrated into the XR representation, wherein the input includes interaction with at least one interactive feature of the at least one IoT device.

17. The computer program product of claim 15, wherein the XR representation of the environment and the plurality of IoT devices are presented to the user through an XR head-mounted display.

18. The computer program product of claim 15, wherein the plurality of IoT devices are identified based on image data received from a camera, wherein the XR representation of the plurality of IoT devices are generated based on the image data.

19-20. (canceled)

21. The computer program product of claim 15, wherein the method performed by the processor further comprises:
storing a plurality of additional XR representations of respective environments, each XR representation of each respective environment having a plurality of XR representations of IoT devices.

22. The computer program product of claim 21, wherein the method performed by the processor further comprises:
displaying a menu depicting the plurality of additional XR representations of respective environments to the user facilitating access to the plurality of additional XR representations of respective environments.

23. The computer program product of claim 22 wherein the method performed by the processor further comprises:
receiving input from the user selecting a desired XR environment of the plurality of additional XR representations of respective environments; and
presenting the desired XR environment to the user.

24. The computer program product of claim 15, wherein a first XR representation of a first IoT device of the plurality of IoT devices has controls that do not virtually mirror controls of the first IoT device in the real-world.

25. The computer program product of claim 15, wherein a second XR representation of a second IoT device of the plurality of IoT devices has at least one control that virtually mirrors controls of the second IoT device in the real-world and at least one control that does not virtually mirror the controls of the second IoT device in the real-world.
